(19) United States
(12) Patent Application Publication
(10) Pub. No.: US 2007/0196560 A1
(43) Pub. Date: Aug. 23, 2007

(54) ALL NATURAL OMEGA ENRICHED PEANUT BUTTER

(76) Inventor: Victor R. Ayoub, Fort Lee, NJ (US)

Correspondence Address: LAWRENCE EDELMAN, ESQ, 3 BUFFALO RUN, EAST BRUNSWICK, NJ, 08816, US

(21) Appl. No.: 11/676,588

(22) Filed: Feb. 20, 2007

Related U.S. Application Data
(60) Provisional application No. 60/774,477, filed on Feb. 18, 2006.

(51) Int. Cl. A23L 1/38

(52) U.S. Cl. 426/633

(57) ABSTRACT

A peanut butter and/or peanut butter spread is disclosed which contains essentially all natural ingredients. The peanut butter and/or peanut butter spread includes peanut particles, peanut oil and a natural stabilizer. Preferred ingredients are described for making the natural stabilizer, and in one embodiment of the invention, the natural stabilizer comprises the Smart Balance product manufactured by GFA.Brands.

### CROSS-REFERENCE TO RELATED APPLICATIONS

This application claims priority under 35USC 120 of U.S. Provisional Patent Application No. 60/774,477, filed Feb. 18, 2006, entitled “All Natural Omega Enriched Peanut Butter”. The entire disclosure of this patent application is incorporated herein by reference in its entirety.

### BACKGROUND OF THE INVENTION

1. Field of the Invention

The invention relates generally to stabilized peanut butter or peanut butter spread, and methods for preparing the same. More particularly, one aspect of the invention relates to the use of a minimum amount of specific ingredients to economically produce a peanut butter stabilizer having a healthy ratio of omega 6 (or omega 6 plus omega 9) to omega 3, such healthy ratio being in the approximate range between 6:1 and 4:1, and preferably of about 4:1.

2. Background Art

Peanut butters are customarily made by first roasting and blanching raw peanuts. The cleaned and roasted peanuts are then subsequently ground to form a pasty peanut base material which is a mixture of peanut particles and peanut oil. The pasty material is typically cooled to form peanut butter and packaged for later use. If the peanut butter is allowed to stand for a period of time, the peanut oil will begin to separate from the peanut particles and form a separate layer on top of the particles and leave a rigid crumbly peanut particle mass underneath.

Several additives have been developed to inhibit or prevent the peanut oil from forming a separate layer after a period of time. Typically, a stabilizer is added to the peanut particle and peanut oil mixture to inhibit the peanut oil separation. It is known that the addition of hydrogenated oils, such as hydrogenated peanut oil, will help stabilize the peanut butter to prevent excessive amounts of peanut oil from separating from the peanut butter. The hydrogenated oils form a crystal matrix with the peanut oil and peanut particles which then forms a rigid mass and inhibits the settling of the peanut particles from the peanut oil. However, if too much hydrogenated oils are added to the peanut butter to prevent peanut oil separation from the peanut particles, the large amount of hydrogenated oils will cause the peanut butter to become excessively firm resulting in a difficult to spread product, and a product which has two undesirable qualities: one, a waxy taste, and two, a tendency to cling to the roof of the mouth when eaten.

As a result, a wide variety of stabilizers have been developed which prevent the separation of the peanut oil from the peanut particles without forming an overly firm product or one having an undesirable aftertaste.

Furthermore, there has been a growing demand for organically grown products as well as all natural products. This trend is partially the result of a belief that products made by all natural ingredients are healthier than products which contain artificial ingredients. Although there are some peanut butters which are packaged and sold as containing only natural ingredients, such all natural peanut butters typically do not include stabilizers. As a result, these natural peanut butters exhibit peanut oil and peanut particle separation. The user must stir the peanut oil into the peanut butter prior to use. This mixing step can be very messy and inconvenient, the separation of the peanut oil from the peanut particles in the peanut butter creates an undesirable looking product for many individuals, and if the peanut oil and peanut particles are not thoroughly mixed, the peanut butter can have an undesirable taste.

In view of the present state of the art of peanut butter manufacture, there is a demand for a peanut butter which is perceived as having healthy and all natural ingredients and which inhibits or prevents the separation of the peanut oil from the peanut particles over an acceptable shelf life time.

Furthermore, in view of the growing consumer concern about cholesterol levels, and the HDL/LDL concentration ratio, there is increasing consumer demand that dietary fats in consumer foods include a preferred healthy balance of various types of omega acids, and specifically omega 6 (or a combination of omega 6 and omega 9) as compared to omega 3 fatty acids.

Although one can make a peanut butter stabilizer using many of the known different ingredients that contain various concentrations of these omega fatty acids, in view of the desirability to keep the peanut content of a peanut butter product at or over 90% in order to meet US FDA truth in labeling laws, it is not apparent which ingredients could be economically combined so as to comprise the remaining 10% or less of the product, and still have an all natural product with a desirable ratio of omega fatty acids.

Furthermore, even if one were to make a peanut butter spread (e.g., a peanut butter product having less than a 90% peanut butter particle base), it is not apparent which ingredients can be economically combined, and it what ratio, to form a stabilizer having a healthy balance of fatty acids.

### DESCRIPTION OF THE INVENTION

The present invention pertains to a peanut butter and/or peanut butter spread which contains essentially all natural ingredients. The peanut butter and/or peanut butter spread includes peanut particles, peanut oil and a natural stabilizer. The natural stabilizer forms a matrix with the peanut oil and peanut particles resulting in a firm peanut butter and/or peanut butter spread which resists the separation of the peanut oil from the peanut particles after the peanut butter and/or peanut butter spread has been packaged. The natural ingredient peanut butter and/or peanut butter spread is preferably produced by conventional methods, such as well know in the art, see for example U.S. Pat. No. 6,153,250. In one embodiment, raw peanuts are cleaned, roasted and blanched. The peanuts are then ground and/or pressed forming a pasty material made of peanut particles and peanut oil. In one aspect of this embodiment, the roasted peanuts are ground between metal grinding plates which have burrs or teeth, and the plates are spaced apart such that a small clearance between the grinding plates exists during the grinding process. The ground peanuts that are forced out the end of the plates are in the form of pasty material made of fine peanut particles in oil. During the grinding process, the resulting pasty material is maintained above about 100 degrees F., and typically between about 120 degrees to 250 degrees F. The natural stabilizer is added and mixed with the pasty mixture to form a substantially homogeneous mixture of peanut particles, peanut oil and natural stabilizer prior to packaging the peanut butter and/or peanut butter spread. In another embodiment, the natural stabilizer is added to the pasty mixture after the pasty mixture exits the grinders and prior to the pasty material being cooled. The natural stabilizer is mixed with the pasty material to form a substantially homogeneous mixture. In one aspect of this embodiment, the natural stabilizer is added to the pasty material in a solid or semi-solid form. When the natural stabilizer is added in a solid or semi-solid form, the temperature of the pasty material is typically maintained at a high enough temperature to cause the solid natural stabilizer to transform into a substantially liquid state so that a substantially homogeneous mixture of peanut particles, peanut oil and natural stabilizer is formed. In another aspect of this embodiment, the natural stabilizer is added in a liquid form.

In still yet another embodiment, the peanut butter includes about 80-90 weight percent peanut particles and peanut oil, and about 20% weight percent or less of natural stabilizer. (Note, under US law, less than 90 weight percent peanut particles and peanut oil can not be called peanut butter and instead must be called peanut butter spread.) In one aspect of this embodiment, the peanut butter includes about 90 weight percent peanut particles and peanut oil, and about 7-10 weight percent natural stabilizer, more preferably about 8 weight percent natural stabilizer. The natural stabilizer can be used in both peanut butter and peanut butter spreads. As used herein, the term peanut butter will be use to describe both peanut butter and peanut butter spreads. In accordance with yet another aspect of the present invention, the natural stabilizer having a desired healthy ratio of omega acids (as described above), is formed from one or more natural fatty acids that form a matrix with the peanut oil and peanut particles in the peanut butter thereby inhibiting or preventing the rapid separation of the peanut oil from the peanut particles after the peanut butter has been packaged. For purposes of economics, as well as a desire to keep the natural stabilizer at less than 10 weight percent of the peanut butter product, and in view of the desire to have a “healthy” omega ratio, one source of the natural fatty acids should be high in omega 6 and omega 9 components, so that a healthy 6:1 to 4:1 omega 6 (or omega plus omega 9) to omega 3 ratio can be achieved.

As noted earlier, during manufacture of the peanut butter, it temperature becomes elevated. In accordance with another aspect of the present invention, before blending in of the stabilizer ingredients, the temperature of the peanut butter mixture should be allowed to cool by an amount sufficient to prevent the omega 3 fatty acids from becoming destabilized.

In accordance with another aspect of the present invention, the peanut butter includes other natural additives. In one embodiment, the natural additives are added to the peanut particles and peanut oil mixture after the peanuts have been ground and before the mixture is fully cooled. In another embodiment, the natural additives are added to the peanut particles and peanut oil mixture after the peanuts have been ground and after the mixture is fully cooled.

In still another embodiment, the natural additives include salt and/or a sweetening agent. In one aspect of this embodiment, a natural salt and/or a sweetening agent is added to the peanut butter. The salt content of the peanut butter is typically less than about 2 weight percent of the peanut butter, preferably about 0.05 to 1.0 weight percent of the peanut butter, and more preferably about 0.4 weight percent of the peanut butter. Typically the salt added to the peanut butter is, but is not limited to, sodium chloride and/or potassium chloride.

The content of the natural sweetening agent in the peanut butter is typically less than about 4 weight percent of the peanut butter, preferably less than about 2 weight percent of the peanut butter and even more preferably about 1.6 weight percent of the peanut butter. Molasses is a preferred natural sweetener which can be added to the peanut butter, but others can be used, such as sucrose, dextrose and/or honey.

It is noted that GFA Brands of Cresskill, N.J. makes a product called “Smart Balance” which is a precisely balanced oil blend to help balance dietary fats by providing a favorable ratio of Omega-6 ( or Omega 6 plus Omega 9) to Omega 3 fatty acids.

In accordance with another aspect of the present invention, the peanut butter stabilizer comprises the Smart Balance product. In accordance with this aspect of the present invention, the peanut butter includes a mixture of 75-90 weight percent peanut base and 25-10 weight percent, that is a substantial amount of the remainder portion, as Smart Balance. Additional ingredients may be between 0%-3% of a natural sweetener (and preferably about 1.6%), where the sweetener preferably comprises molasses, and between 0.0%-0.6% of salt, and preferably about 0.4% of salt.

Finally, it is noted that the moisture content of the final peanut butter product may be controlled to obtain an acceptable water activity of the peanut butter and to reduce the rate at which the peanut oil separates from the peanut particles. A water activity that is too great can significantly reduce the shelf-life of the peanut butter product. Too high of a water content in the peanut butter can reduce the effectiveness of the natural stabilizer thereby causing an increase in the settling rate of the peanut particles from the peanut oil in the peanut butter. Typically, the moisture content of the final peanut butter is less than about 4 weight percent of the peanut butter.

While the present invention has been disclosed with reference to certain embodiments as described above, and claimed below, numerous modifications, alterations and changes to the described embodiments and claims are possible without departing from the sphere and scope of the present invention (as described above and claimed below).

For example, since sugar beet molasses, cane molasses or honey and other known equivalents, for example, can be used as the natural sweetener. Furthermore, it is noted that hemp oil is rich in omega acids, and in particular its fatty acid content is about 70% omega 6 and omega 9. Thus, it can be effectively used in place of flax seed oil, and specifically can be economically combined palm fruit oil, which is also rich in omega 6+9 (about 50%), as well as having about 20% omega 3. Thus, less of one or more of the palm oils can be used, as an appropriate amount of hemp oil is substituted therefore. It is also noted that hemp oil has a somewhat nutty flavor, which also is beneficial, whereas fish oil, which is otherwise another good source of omega fatty acids, is a less desirable ingredient due to its “fishy” flavor. It is also noted that hemp oil is advantageous because it is stable at higher temperatures than one or more of the other ingredients used to form the all natural stabilizer.

Accordingly, it is intended that the present invention not be limited to the described embodiments, but that it has the full scope defined by the above language and the following claims, as well as equivalents and obvious variations thereof

The following paragraph is illustrative of various ingredients, combinations and ratios in accordance with the principles of the invention, and is not intended to be a limited definition of applicant's contribution to the art.

An omega enriched peanut butter stabilized against oil separation, where a peanut base contributes to the peanut butter by at least 90% by weight peanut particles and peanut oil, the omega enriched peanut butter comprising:
at least 90% by weight peanut base (where the peanut base includes peanut particles and peanut oil),
between about 3% and 5% (and preferably between about 4%) by weight of a first edible ingredient high in omega 3 (preferably flax oil),
between 3% and 5% (and preferably between about 4%) by weight a second edible ingredient high in one or both of oleic acid and linoleic acid (and preferably such ingredient(s) is derived from one or more of palm oil, palm fruit oil, palm kernel oil or hemp oil),
between 0%-3% a natural sweetener (and preferably about 1.6%, and preferably the sweetener substantially comprises molasses), and
between 0%-0.6% (and preferably 0.4%) salt,
wherein the first and second edible ingredients combine so as to cause said stabilizer to have a fatty acid ratio of Omega 6 (or a combination of Omega 6 and Omega 9) to Omega 3 in the approximate range between 6:1 and 4:1, and preferably, close to 4:1.

An omega enriched stabilizer component for combining with a peanut base component for making an omega enriched peanut butter stabilized against oil separation, where the peanut base component contributes to the final combination at least 90% by weight peanut particles and peanut oil, the stabilizer component comprising:
between 25% and 80% (and preferably between 30%-40%) by weight an edible flax oil,
between 25% and 80% (and preferably between 30%-40%) by weight of one or more of palm oil, components of palm oil or hemp oil,
between 0%-20% a natural sweetener (and preferably 14%-18%) molasses, and
between 0%-6% (and preferably 3-5%) salt,

1. An omega enriched peanut butter stabilized against oil separation, where a peanut base contributes to the peanut butter by about 75%-90% by weight peanut particles and peanut oil, the omega enriched peanut butter comprising:
about 75%-90% by weight peanut particles and peanut oil,
about 25%-10% weight percent Smart Balance.

2. The peanut butter of claim 1, where the sweetener preferably comprises molasses.

3. The peanut butter of claim 1, further including:
about 0%-3% natural sweetener, and
about 0.0%-0.6% salt.

4. The peanut butter of claim 3, where:
the natural sweetener is preferably about 1.6%, and
the salt is preferably about 0.4%

5. An omega enriched peanut butter stabilized against oil separation, where a peanut base contributes to the peanut butter by at least 90% by weight peanut particles and peanut oil, the omega enriched peanut butter comprising:
at least 90% by weight peanut base,
less than 10% by weight of a blend of two or more ingredients for forming a fat blended stabilizer for the peanut base,
a first of said two or more ingredients being one which contains a high level of omega 6 and/or omega 9 fatty acids, and
a second of said two or more ingredients being one which contains a high level of omega 3 fatty acids
where the percentage weight in the fat blended stabilizer of each of said first and second two or more ingredients is determined so that after blending said two or more ingredients, the fat blended stabilizer has a fatty acid ratio of Omega 6 (or a combination of Omega 6 and Omega 9) to Omega 3 in the approximate range between 6:1 and 4:1, and preferably, close to 4:1.

6. The peanut butter of claim 5, where the peanut base includes peanut particles and peanut oil

7. The peanut butter of claim 5, where two ingredients are used to substantially establish the omega ratio of the fat blended stabilizer, the first ingredient being formed from one or more of palm oil, palm kernel oil, palm fruit oil and hemp oil and the second ingredient being formed from one or more of flax or flax seed oil.

8. The peanut butter of claim 7, where only two ingredients are used to substantially establish the fatty acid omega ratio in the fat blended stabilizer, the first ingredient being formed substantially as a derivative from a palm oil, and the second ingredient being formed substantially from a flax oil.

9. The peanut butter of claim 5, further including:
between 1%-3% a natural sweetener, and preferably about 1.6%.

10. The peanut butter of claim 6, further including:
between 1%-3% a natural sweetener, and preferably about 1.6%.

11. The peanut butter of claim 8, further including:
between 1%-3% a natural sweetener, and preferably about 1.6%.

12. The peanut butter of claim 9, wherein said natural sweetener comprises molasses.

13. The peanut butter of claim 11, wherein said natural sweetener comprises molasses.

14. The peanut butter of claim 5, further including:
between 0.2%-0.6% salt, and preferably about 0.4%.

15. The peanut butter of claim 9, further including:
between 0.2%-0.6% salt, and preferably about 0.4%.

16. The peanut butter of claim 13, further including:
between 0.2%-0.6% salt, and preferably about 0.4%.

17. An omega enriched peanut butter stabilized against oil separation, where a peanut base contributes to the peanut butter at least 90% by weight peanut particles and peanut oil, the omega enriched peanut butter comprising:
at least 90% by weight peanut particles and peanut oil,
between about 3% and 5% (and preferably between about 4%) by weight an edible flax oil,
between 3% and 5% (and preferably between about 4%) by weight of one or more of palm oil, components of palm oil or hemp oil,
between 0%-3% a natural sweetener (and preferably about 1.6%) molasses, and
between 0.0%-0.6% (and preferably 0.4%) salt,
wherein the palm oil or components of palm oil combine with the flax oil so as to cause said stabilizer to have a fatty acid Omega 6 to Omega 3 ratio of approximately 4:1.

18. An omega enriched peanut butter stabilized against oil separation, comprising:
a base component comprised of peanuts,
a flaxseed oil component,
a palm fruit oil component
salt, and
molasses.

19. The peanut butter of claim 18, wherein said a flaxseed oil and said palm fruit oil components are blended together so as to form an omega-rich fat blended stabilizer for the peanut base component.

20. The peanut butter of claim 19, wherein:
the peanut base is at least 90% by weight of the peanut butter,
the blend of the flaxseed oil and the palm fruit oil components are less than 10% by weight of the peanut butter,
the salt is between 0.0%-0.6% by weight of the peanut butter, and
the molasses is between 0%-3% by weight of the peanut butter.
